(19) United States
(12) Patent Application Publication
(10) Pub. No.: US 2012/0260484 A1
(43) Pub. Date: Oct. 18, 2012

(54) MECHANICAL CONNECTION OF THIN-WALLED COMPONENTS THAT MUST SATISFY OPTICAL REQUIREMENTS

(76) Inventors: Dirk Bücker, Monchengladbach (DE); Hergen Görse, Roth (DE); Anton Sautner, Treuchtlingen (DE); Wieland Wegener, Pleinfeld (DE); Stefan Meder, Weissenburg (DE); Andreas Helfenberger, Weissenburg (DE); Harry Schneikert, Treuchtlingen (DE)

(21) Appl. No.: 13/514,643

(22) PCT Filed: Dec. 13, 2010
(86) PCT No.: PCT/EP10/69458

§ 371 Date: Jun. 21, 2012

(30) Foreign Application Priority Data
Dec. 11, 2009 (DE) 10 2009 057 859.5

(51) Int. Cl. B23P 11/00

(52) U.S. Cl. 29/428

(57) ABSTRACT

A method for connecting a component having a visually relevant front and a visually irrelevant rear to an add-on component. In order to make it possible to interconnect flat components, such as bumpers, by mechanical dovetailing, thereby ensuring a cost-effective way of interconnecting thin-walled fiat class A painted components, recesses are produced in the rear of the component, said recesses being oriented at different angles to the surface normal of the rear of the component. The recesses do not break through the visually relevant front but end at such a distance to the front at which no visible deformations to the front are produced. The add-on component is then mortised and form-locked with the component via connecting bodies, said connecting bodies being inserted with one end into the recesses and with the other end projecting through the add-on component or being fastened thereto.

The invention relates to a method for connecting a component with an optically relevant front and an optically irrelevant rear with an attachment.

### PRIOR ART

In principle there are three possibilities available for connecting components to one another.

Thermal Joining Technique: Welding

With welding, with the aid of pressure and temperature as a rule two joining parts are thermally connected in various ways, for example, by friction welding, ultrasonic welding, etc. It is common to all techniques that a plasticizing process occurs in the joint region due to power supply, which generates a deep connection between the joining parts.

Specifically with use in the field of automobile exteriors, due to the possibilities that new material properties provide in injection molding, the common wall thicknesses in processing are currently in the range of>=3.0 mm. The type of material hereby used on a standard basis is, due to the price, talc-filled PP. Due to the thin wall thickness, the cost and weight of the component are reduced. However, since specifically PP has a high creeping capability under load with respect to other technical plastics and has a very low modulus of elasticity, but at the same time the demands made on the component welding of holding forces on the welding component bond of>200 N for each welding point remain unchanged, it is often impossible to connect the components in a manner free from faults. Above all the inserted power for plasticizing and deep connection of the split planes obstructs a connection free from indentations, since it has an effect through the component such that the surface is deformed as a result of the shrinkage difference during cooling and a defect is formed.

Chemical Joining Technique: Adhesion

With adhesion, substances are chemically introduced into the split plane, which develop a holding force in the form of adhesive forces due to cross-linking reactions between the joining parts. Specifically in the field of polyolefin materials such as PP and PE, the effective systems are expensive and generally can be used only with complex pretreatment of the surfaces.

Mechanical Joining Technique: Clipping

Due to the danger of indentation of the necessary web connection of the clip to the optically relevant surface can be used only in the non-flat region, for example, in ribbing or edge zones of a painted plastic body.

Criticism of the Prior Art:

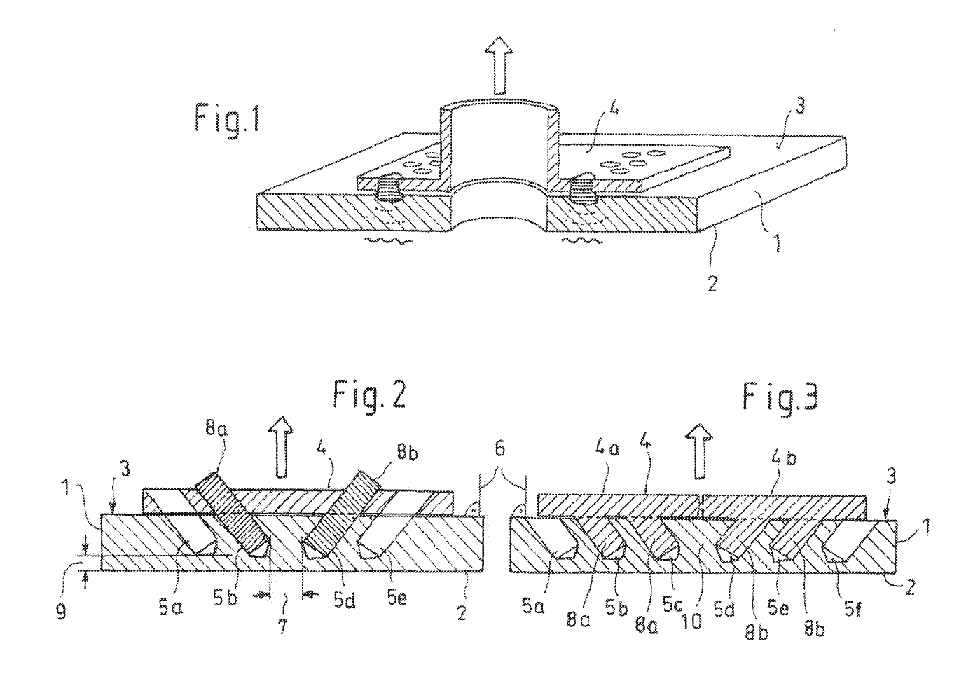

Currently no technique is available that makes it possible to guarantee the function of holding three and optical appearance simultaneously under flat Class A painted. components of PP with a wall thickness <=3 mm in a sufficiently cost-effective manner.
Thermal methods such as fakir sonotrode welding (see FIG. 1 or EP 1 250 996 B1) require a wall thickness >3.3 mm under flat painted surfaces.
Chemical methods, such as adhesion, are not cost-effective.
Mechanical methods, such as clipping, cannot be used for Class A painted thin walled plastic parts, since the connection to the optically relevant component, the web of the clip, on flat surfaces immediately leads to an optically visible sink mark on the painted exterior wall opposite the clip foot/rib foot.

Most of the components to be welded in the field of automobile construction are large, usually flat, such as bumpers. The object of the invention is to make these bodies and geometries accessible for connection by means of mechanical meshing and thus to guarantee a connection of thin-walled, flat Class A painted components in a cost-effective manner.

The object is attained according to the following description and FIGS. 2 and 3.

As has been shown in tests, it is possible to develop a sufficient holding force between the components to be connected by means of a mechanical locking of the two joining parts (component and attachment). To this end:
1.) The optically relevant component is provided on its rear with several recesses that are aligned at different angles to the surface normal. The recesses do not break through the optically relevant surface hereby, but keep a distance from it that just does not produce any visible deformations on the surface. With PP components this distance is approx. 0.5 mm.
2.) The component is positioned above the field of the recesses inserted.
3.) The components are mortised to one another and positively connected. This can be carried out fundamentally in two ways.
   a) By securing by pins in the case that the cavity made in the outer part continues in the inner part.
   b) By a bisection of the inner part, which makes it possible to provide in each component a quantity of journals aligned identically, which project beyond the split plane and plunge into a matching quantity of recesses in the outer part. The positioning is held by means of subsequent locking in place of the components in their end position, for example, clamping or clipping, and force can be built up with different alignment of the journals among the two components due to the positive connection.

Because recesses are made on the rear of the component which are aligned at different angles to the surface normal of the rear of the component, wherein the recesses do not penetrate through the optically relevant front, but end at such a distance from the front in which no visible deformations are produced on the front and subsequently the attachment is mortised and connected positively to the component via connecting bodies, wherein the connecting bodies on the one hand are inserted into the recesses and on the other hand project through the attachment or are attached thereto, areal thin-walled flat class A painted components, such as bumpers, can be connected by means of mechanical meshing.

Advantageously, the recesses are bores.

Recesses are generally also understood to mean cavities. Recesses and cavities can also be easily made by laser processing.

In a preferred embodiment a first number of recesses are inserted at a first angle to the surface normal and a second number of recesses (opposed recesses) at a second angle to the surface normal. The attachment cannot be detached from the component hereby.

It has proven to be advantageous thereby if the recesses are inserted in an opposed manner to a later load direction. The term opposed is understood broadly and comprises recesses that run in a different direction from the later load direction.

In order for a lasting and firm anchoring to be achieved, the distance between two opposed recesses should be less than 20 mm.

It is important that the recesses are inserted such that their end has a distance from the front of greater than 0.5 mm. This ensures the intactness of the optically relevant front of the component.

In one embodiment, the connecting bodies are embodied in a pin-shaped manner. These can easily be inserted into the recesses.

Expediently, the entry of the recesses into the component is covered by the attachment, One advantage is that the entry of the recesses is invisible and another advantage is that the connecting bodies cannot be detached from the bore.

In another embodiment, which is shown in FIG. 3, the attachment is designed in a two-part manner and both parts of the attachment are embodied so they can be connected to one another, wherein on the first part only connecting bodies are arranged that run at a first identical angle to the surface normal and on the second part only connecting bodies are arranged that run at a second identical angle to the surface normal so that only connecting bodies of the same alignment are attached to each of the two parts. The angles of the recesses on the first and on the second part are different from one another. The figures show this in a self-explanatory manner.

The connecting bodies on the attachment are preferably molded on.

Preferably, the attachment as well as the component is produced from plastic.

Preferably, the space between the connecting bodies of dissimilar alignment is designed such that it can be temporarily expanded without damage by suitable structural design. This simplifies the meshing.

Preferably, the attachment embodied in a one-part or two-part manner is first placed on the component in the end position and then the connecting bodies are inserted in the joining process.

The use of the method just described is preferred for components from the automobile field, preferably in the field of optically relevant, e.g. painted surfaces or painted that surfaces with particularly sensitive surfaces.

The use in the automobile field is preferably in the field of the exterior of motor vehicles and there preferably for bumpers on motor vehicles.

FIG. 1 shows fakir sonotrode welding, which belongs to the prior art, with which an attachment 4 is welded to a component In order that no visible traces occur on the front 2, the wall thickness of the component I must be greater than 3.3 mm.

A method according to the invention is described in FIGS. 2 and 3.

A component 1, here a bumper for a motor vehicle, has an optically relevant front 2 and an optically irrelevant rear 3, Optically relevant means that the highest demands are made on the visual appearance, i.e. that it is a class A painted component.

Recesses 5, in this case 5a, 5b, 5d, 5e are inserted into the component 1 for connecting an attachment 4 to the component 1. There is a distance greater than 0.5 mm between the end of the recesses 5 and the front in order to ensure the intactness of the front 2. Both parts, the component 1 and the attachment 4, are made of plastic.

The recesses are bores in the embodiment shown here. However, they can also be cavities that are inserted by laser processing.

In the embodiment of FIG. 2 two recesses 5a, 5b have been inserted with an identical angle to the surface normal 6 and two recesses 5d, 5d at a different angle to the surface normal 6. The bore 5a is arranged parallel to the bore 5b and the bore 5d is arranged parallel to the bore 5e. In the attachment 4 four through recesses have been inserted, which are adapted with their angles to the recesses in the component 1. The recesses 5a, 5b are arranged at a right angle to the recesses 5d, 5e, To fasten the attachment 4 to the component 1, the attachment 4 is placed onto the component 1 and subsequently pin-shaped connecting bodies 8a, 8b are inserted through the recesses in the attachment into the recesses 5d, 5e and mesh or key both parts to one another.

FIG. 3 shows an embodiment in which three recesses 5a, 5b, 5c running parallel to one another and three recesses 5d, 5e, 5f running parallel to one another have been inserted. Here too the recesses 5a, 5b, 5c are arranged at a right angle to the recesses 5d, 5c, 5f The attachment 4 is composed of the two parts 4a, 4b, which are connected to one another. Two pin-shaped connecting bodies 8a are arranged on the first part 4a and two pin-shaped connecting bodies 8b are arranged on the second part 4b. The connecting bodies 8a and 8b have been molded onto the attachment 4. For connecting the parts 4a, 4b are stretched on the cavity a little apart from one another and then placed onto the component 1 such that the connecting bodies 8a, 8b can penetrate into the recesses 5 and key there.

1-15. (canceled)

16. A method for connecting a component with an optically relevant front and an optically irrelevant rear with an attachment, wherein on the rear of the component recesses are inserted that are aligned at different angles to the surface normal of the rear of the component, wherein the recesses do not break through the optically relevant front, but end at such a distance from the front in which no visible deformations are produced. on the front and subsequently the attachment is mortised and positively connected to the component via connecting bodies, wherein the connecting bodies on the one hand are inserted into the recesses and on the other hand penetrate through the attachment or are attached thereto.

17. The method according to claim 16, wherein a first number of recesses (are inserted at a first angle to the surface normal and a second number of opposed recesses at a second angle to the surface normal.

18. The method according to claim 16, wherein the recesses are inserted in an opposed manner to a later load direction.

19. The method according to claim 16, wherein the distance between two opposed recesses is less than 20 mm.

20. The method according to claim 16, wherein the recesses are inserted such that their end has a distance from the front of greater than 0.5 mm.

21. The method according to claim 16, wherein the connecting bodies are embodied in a pin-shaped manner.

22. The method according to claim 16, wherein the entry of the recesses into the component is covered by the attachment.

23. The method according to claim 22, wherein the attachment is designed in a two-part manner and both parts of the attachment are embodied so they can be connected to one another, wherein on the first part only connecting bodies are arranged that run at a first identical angle to the surface normal and on the second part only connecting bodies are arranged that run at a second identical angle to the surface normal so that only connecting bodies of the same alignment are arranged on each of the two parts.

24. The method according to claim 16, wherein the connecting bodies are molded onto the attachment.

25. The method according to claim 24, wherein the attachment as well as the component is produced from plastic.

26. The method according to claim 16, wherein the space between the connecting bodies of dissimilar alignment is designed such that it can be temporarily expanded without damage by suitable structural design.

27. The method according to claim 16, wherein the attachment embodied in a one-part or two-part manner is first placed on the component in the end position and then the connecting bodies are inserted in the joining process.
